(19) United States
(12) Patent Application Publication
(10) Pub. No.: US 2025/0063127 A1
(43) Pub. Date: Feb. 20, 2025

(54) OPTICAL DEVICE

(71) Applicant: FUJIFILM Business Innovation Corp., Tokyo (JP)

(72) Inventor: Masaki HACHISUGA, Kanagawa (JP)

(73) Assignee: FUJIFILM Business Innovation Corp., Tokyo (JP)

(21) Appl. No.: 18/595,093

(22) Filed: Mar. 4, 2024

(30) Foreign Application Priority Data
Aug. 14, 2023 (JP) 2023-131972

(51) Int. Cl. H04N 1/031

(52) U.S. Cl. CPC H04N 1/0311; H04N 1/0315; H04N 1/0318

(57) ABSTRACT

An optical device includes a light shielding wall including a light shielding portion that shields light from a light source, a first through-hole and a second through-hole that allow passage of light from the light source, the second through-hole having a smaller diameter than the first through-hole, and a cutout portion that forms the second through-hole, a microlens array configurated by a plurality of lenses that condenses light having passed through the first through-hole and the second through-hole, and an image sensor that reads the light condensed by the microlens array.

### CROSS-REFERENCE TO RELATED APPLICATIONS

This application is based on and claims priority under 35 USC 119 from Japanese Patent Application No. 2023-131972 filed Aug. 14, 2023.

### BACKGROUND

### (i) Technical Field

The present disclosure relates to an optical device.

### (ii) Related Art

There is a known technique to control the optical performance (e.g., stray light, the depth of focus, and the amount of light) of a reading device of a contact optical system (contact image sensor (CIS)) configurated to include a microlens array that condenses light from a light source and a light reception substrate including an image sensor that reads the condensed light. For example, Japanese Unexamined Patent Application Publication No. 2003-302504 describes that a light shielding wall, in which a plurality of through-holes allowing passage of light from a light source is formed, is provided between the light source and a microlens array. According to such a technique, there is a possibility of the occurrence of misregistration due to a difference between the contraction rate of the microlens array and the contraction rate of the light shielding wall, and therefore the light shielding wall is divided in the longitudinal direction and is positioned such that a gap is formed in consideration of the contraction rate so that misregistration may be reduced.

### SUMMARY

However, an unintended amount of light may leak out depending on the shape of the gap between the dividedly positioned light shielding walls. In this case, when the amount of leaked light exceeds the range in which shading correction may be performed, the leaked light may become stray light that affects image generation.

Aspects of non-limiting embodiments of the present disclosure relate to suppressing the amount of light leaking out of the gap between the dividedly positioned light shielding walls to within the range in which shading correction may be performed.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an optical device including a light shielding wall including a light shielding portion that shields light from a light source, a first through-hole and a second through-hole that allow passage of light from the light source, the second through-hole having a smaller diameter than the first through-hole, and a cutout portion that forms the second through-hole, a microlens array configurated by a plurality of lenses that condenses light having passed through the first through-hole and the second through-hole, and an image sensor that reads the light condensed by the microlens array.

### BRIEF DESCRIPTION OF THE DRAWINGS

Exemplary embodiments of the present disclosure will be described in detail based on the following figures, wherein:

FIG. 1A is a perspective view illustrating an example of an external configuration of an image reading device as an optical device to which a first exemplary embodiment is applied;

FIG. 1B is a schematic configuration diagram of the image reading device;

FIG. 2A is a schematic configuration diagram of a contact image sensor (CIS) configurating the image reading device; FIG. 2B is a diagram illustrating a state in which the light reflected by a document is received by a light reception element of the image sensor;

FIG. 3 is a front view illustrating an example of an arrangement configuration of a light shielding wall and a microlens array;

FIGS. 4A to 4C are plan views illustrating an example of a configuration of a second through-hole formed in the light shielding wall;

FIG. 5 is a plan view illustrating an example of an external configuration of a light shielding film provided between a light shielding wall and the microlens array in a CIS of an image reading device according to a second exemplary embodiment; and

FIGS. 6A to 6C are diagrams illustrating an example of an external configuration of a light shielding wall mounted on a CIS of an image reading device according to a third exemplary embodiment.

### DETAILED DESCRIPTION

In the following description, an exemplary embodiment of the invention will be described in detail with reference to the accompanying drawings.

### First Exemplary Embodiment

### (Image Reading Device)

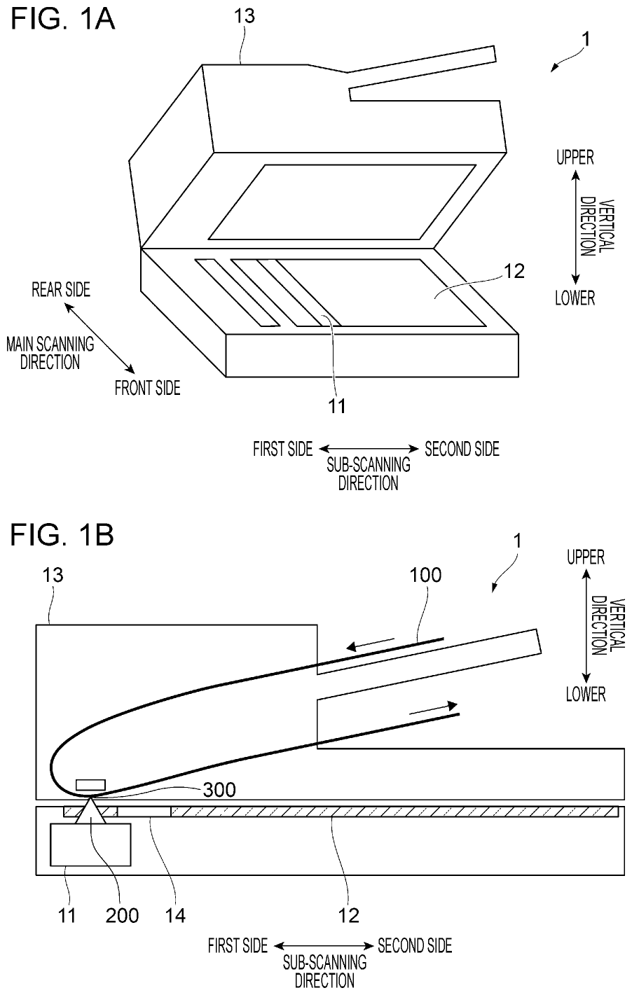

FIG. 1A is a perspective view illustrating an example of an external configuration of an image reading device 1 as an optical device to which a first exemplary embodiment is applied. FIG. 1B is a schematic configuration diagram of the image reading device 1.

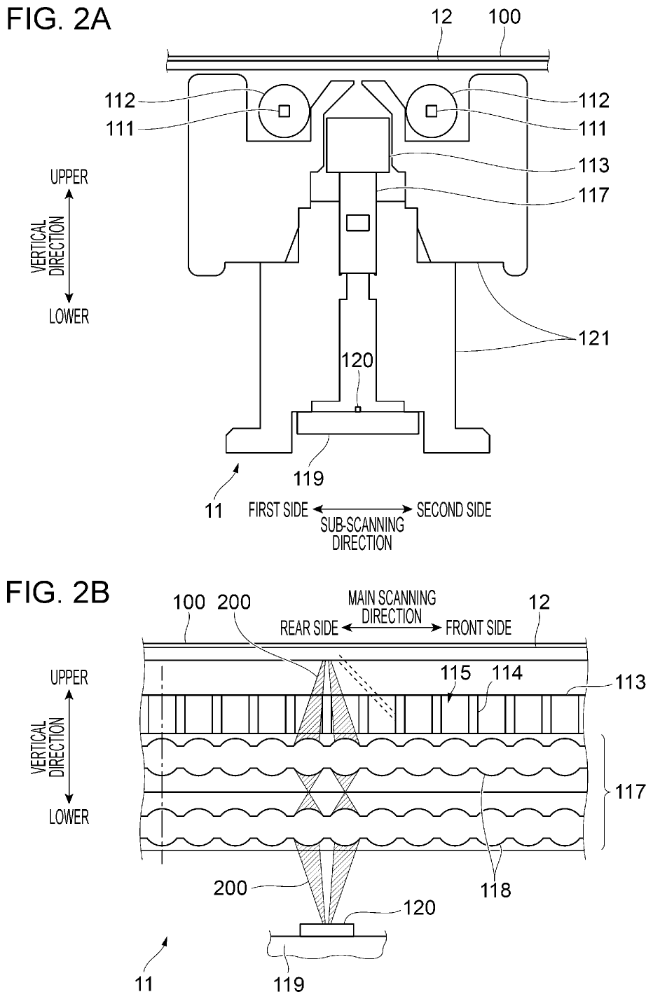

FIG. 2A is a schematic configuration diagram of a contact image sensor (CIS) 11 configurating the image reading device 1. FIG. 2B is a diagram illustrating a state in which the light reflected by a document 100 is received by a light reception element 120 of an image sensor 119.

The image reading device 1 illustrated in FIGS. 1A and 1B is a device that reads an image formed on the document 100 and is configurated to include the CIS 11, a document glass 12, an automatic document feeder (ADF) 13, and a white correction plate 14. The CIS 11 is an optical device of a contact optical system that reads an image formed on the document 100.

As illustrated in FIGS. 2A and 2B, the CIS 11 includes a light source 111, a light guide 112, a light shielding wall 113, a microlens array 117, the image sensor 119, and a housing 121. The light source 111 is a light emitting diode (LED), or the like, and outputs light 200 illustrated in FIGS. 1B and 2B. The light guide 112 is a member that guides the light 200 from the light source 111 to the document 100. The light sources 111 and the light guides 112 are arranged to emit the light 200 to the document 100 from a plurality of directions.

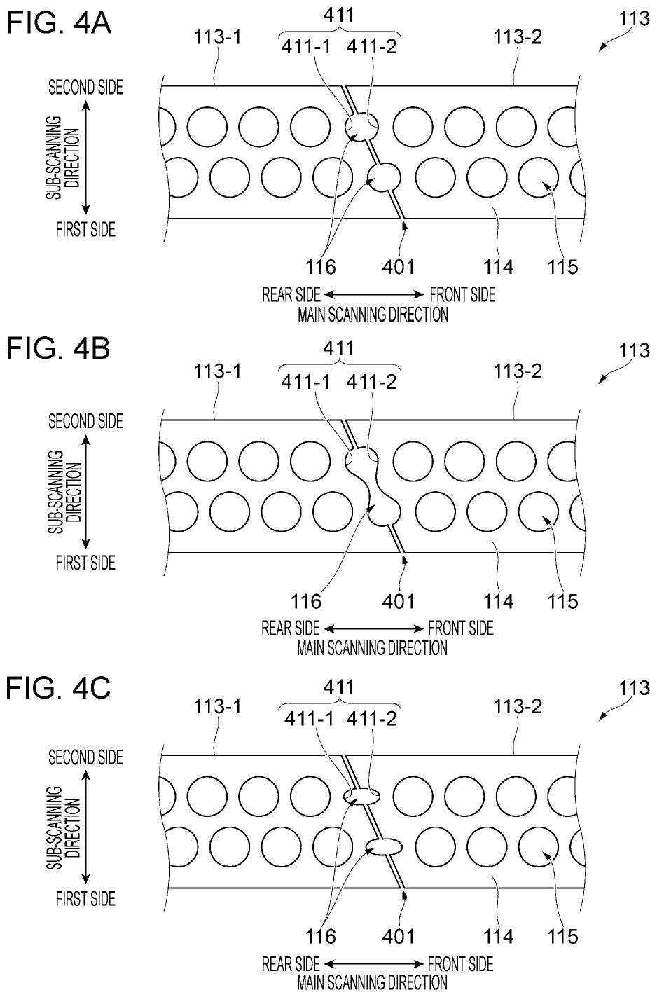

The light shielding wall 113 is a member that controls the amount of the light 200 incident on the microlens array 117 described below and is provided at an upper surface of the microlens array 117 in a vertical direction. As illustrated in FIG. 2B, the light shielding wall 113 includes a light shielding portion 114 and a first through-hole 115. Although not illustrated in FIG. 2B, the light shielding wall 113 includes a second through-hole in addition to the first through-hole 115. The second through-hole will be described below with reference to FIGS. 4A to 4C and the subsequent drawings.

The light shielding portion 114 is a wall that blocks the passage of the light 200. The first through-holes 115 are a plurality of holes penetrating the light shielding portion 114 in the vertical direction and allow passage of the light 200. The light shielding wall 113 uses the light shielding portion 114 and the first through-hole 115 to control the amount of the light 200 passing therethrough toward the microlens array 117. Specifically, for example, the light shielding wall 113 performs control to make the incident angle of the light 200 gradual so that the degree of route change of the light 200 refracted by a microlens 118 becomes gradual. Since the light shielding wall 113 has the above configuration, what is called pitch unevenness and stray light (broken lines in FIG. 2B) are suppressed and the uniformity of the amount of light is ensured. Furthermore, the spread of the light 200 in the vicinity of the focal point is suppressed, and a long depth of focus is achieved.

The microlens array 117 is a lens configurated by a plurality of the fine microlenses 118 that condense the light 200 having passed through the first through-hole 115 of the light shielding wall 113. The microlenses 118 are arranged such that the optical axes thereof extend along each other and elongated in the main scanning direction. As the microlens array 117, for example, as illustrated in FIG. 2B, two lens arrays of erecting equal-magnification imaging with less magnification variation due to misregistration are used.

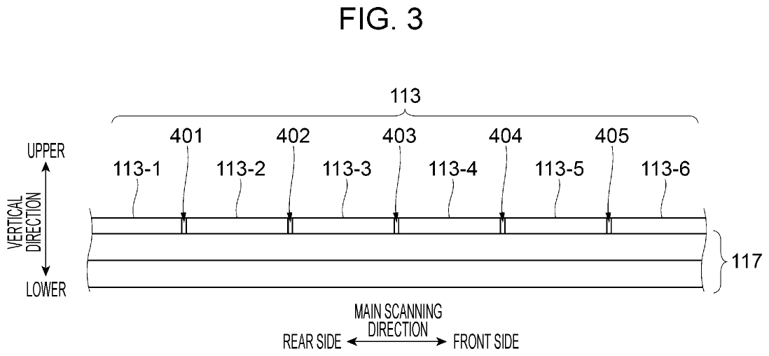

The arrangement relationship between the microlens array 117 and the light shielding wall 113 is such that each of the plurality of microlenses 118 configurating the microlens array 117 and each of the plurality of first through-holes 115 (see FIG. 2B) configurating the light shielding wall 113 are arranged to have a paired relationship. Specifically, the arrangement is such that the central axis in the vertical direction of one of the first through-holes 115 and the central axis in the vertical direction of one pair of the microlenses 118 arranged in the vertical direction are coaxial (a dash-dotted line in FIG. 2B) or substantially coaxial. The details of the arrangement configuration of the microlens array 117 and the light shielding wall 113 will be described below with reference to FIG. 3 and the subsequent drawings.

The image sensor 119 includes the light reception elements 120 arranged in a row at intervals in the main scanning direction and performs reading by receiving the light 200 condensed by the microlens array 117. The housing 121 is a member that holds the light source 111, the light guide 112, the light shielding wall 113, the microlens array 117, and the image sensor 119. The housing 121 functions as a member that positions the light shielding wall 113 and the image sensor 119.

The document glass 12 is a document table that supports the document 100, which is an object to be read by the CIS 11. The ADF 13 illustrated in FIGS. 1A and 1B is an auto document feeder that feeds the document 100 to a reading position 300 of the CIS 11. The white correction plate 14 illustrated in FIG. 1B is a white member to acquire shading data in the shading correction performed before the CIS 11 starts to read the document 100. The shading correction refers to processing for correcting lens aberration and illumination unevenness.

### (Arrangement Configuration of Light Shielding Wall and Microlens Array)

FIG. 3 is a front view illustrating an example of an arrangement configuration of the light shielding wall 113 and the microlens array 117.

The light shielding wall 113 and the microlens array 117 mounted on the CIS 11 are both arranged such that the longitudinal direction is parallel to the main scanning direction. Since the light shielding wall 113 has a higher contraction rate due to an environmental change such as a temperature change or moisture absorption than the microlens array 117, the light shielding wall 113 is provided with a gap that functions as an allowance to absorb contraction and expansion of its own.

Specifically, the light shielding wall 113 is divided into a plurality of parts in the longitudinal direction (i.e., the main scanning direction), and a gap is formed between the adjacent light shielding walls 113. FIG. 3 illustrates, as an example, gaps 401 to 405 formed by dividing the light shielding wall 113 into light shielding walls 113-1 to 113-6. The length of each of the gaps 401 to 405 in the main scanning direction is set to a length at which the light shielding walls 113-1 to 113-6 do not come into contact with each other even with thermal expansion due to a normal temperature increase. Specifically, the gap is approximately 0.1 millimeters (mm) at the shortest portion.

### (Second Through-Hole)

FIGS. 4A to 4C are plan views illustrating an example of the configuration of a second through-hole 116 formed in the light shielding wall 113.

The light shielding wall 113 illustrated in FIGS. 4A to 4C includes the light shielding portion 114 and the plurality of first through-holes 115 having a circular shape in cross-section. The plurality of first through-holes 115 is arranged in rows at equal intervals or substantially equal intervals in the main scanning direction. Specifically, the plurality of first through-holes 115 is arranged in a row on each of a first side and a second side of the light shielding wall 113 in the sub-scanning direction. Furthermore, the light shielding wall 113 includes a cutout portion 411 that divides the light shielding wall 113 itself in the longitudinal direction (i.e., the main scanning direction). FIGS. 4A to 4C illustrate the light shielding wall 113-1 and the light shielding wall 113-2 among the divided light shielding walls 113 and the gap 401 formed therebetween.

The light shielding wall 113-1 includes a cutout portion 411-1 at an end portion on the front side in the main scanning direction. Further, the light shielding wall 113-2 includes a cutout portion 411-2 at an end portion on the rear side in the main scanning direction. The cutout portions 411-1 and 411-2 configurating a part of the cutout portion 411 form the second through-hole 116. Although the second through-hole 116 allows passage of the light as is the case with the first through-hole 115, the second through-hole 116 is formed to have a diameter or a cross-sectional area smaller than that of the first through-hole 115. Therefore, the amount of passing light of the second through-hole 116 is smaller than that of the first through-hole 115.

Here, the shapes of the cutout portions 411-1 and 411-2 are determined in consideration of a change in the positional relationship between the first through-hole 115 and the second through-hole 116 and the microlens 118 due to an environmental change such as a temperature change or moisture absorption. For example, when a temperature increase as an environmental change occurs, each of the light shielding wall 113-1 and the light shielding wall 113-2 thermally expands, and the gap 401 is narrowed. Therefore, the cutout portions 411-1 and 411-2 have shapes in consideration of the contraction rate such that the light shielding wall 113-1 and the light shielding wall 113-2 do not come into contact with each other even with thermal expansion due to a normal temperature increase and the gap 401 is ensured.

Furthermore, the cutout portions 411-1 and 411-2 have shapes in consideration of not only the contraction rate of the light shielding wall 113 but also the contraction rate of the microlens array 117 (see FIG. 3). As described above, since the contraction rate of the microlens array 117 is lower than the contraction rate of the light shielding wall 113, a change in the position of the microlens 118 at the time of thermal expansion due to a normal temperature increase is smaller than a change in the position of the first through-hole 115 or the second through-hole 116 at the time of thermal expansion of the light shielding wall 113. Therefore, for example, the cutout portions 411-1 and 411-2 have shapes in consideration of changes in the positions of the end portion on the front side of the light shielding wall 113-1 in the main scanning direction, the end portion on the rear side of the light shielding wall 113-2 in the main scanning direction, and the plurality of microlenses 118 when the light shielding wall 113 and the microlens array 117 thermally expand due to a normal temperature increase. Specifically, the cutout portions 411-1 and 411-2 have shapes in consideration of suppressing the amount of change in the amount of light passing through the first through-hole 115 and the second through-hole 116 before and after a normal temperature increase.

The cross-sectional shape of the second through-hole 116 is not particularly limited and is configurated by, for example, a circular shape, an elliptical shape, a rectangular shape, or a gourd shape. The cross-sectional shape of the second through-hole 116 may be determined based on the shape and the size of the microlens 118 of the microlens array 117. For example, when the shape of the microlens 118 is circular, accordingly, the cross-sectional shape of the second through-hole 116 may also be circular.

FIGS. 4A to 4C each illustrate variations of the shape of the second through-hole 116. For example, FIG. 4A illustrates the two second through-holes 116 formed by the cutout portion 411. Each of the two second through-holes 116 illustrated in FIG. 4A is a through-hole having a circular shape in cross-section and is formed to have a diameter smaller than that of the first through-hole 115. Therefore, the amount of passing light is smaller than that of the first through-hole 115.

Furthermore, FIG. 4B illustrates the one second through-hole 116 formed by the cutout portion 411. The one second through-hole 116 illustrated in FIG. 4B is a through-hole having a gourd shape in cross-section and is formed such that the diameter of each of two circular portions forming the gourd shape is smaller than that of the first through-hole 115. Therefore, the amount of light passing through the one second through-hole 116 illustrated in FIG. 4B is smaller than the amount of light passing through the two first through-holes 115.

Furthermore, FIG. 4C illustrates the two second through-holes 116 formed by the cutout portion 411. Each of the two second through-holes 116 illustrated in FIG. 4C is a through-hole having an elliptical shape in cross-section and is formed such that at least one of the diameter in the main scanning direction and the diameter in the sub-scanning direction is smaller than that of the first through-hole 115. Therefore, the amount of passing light is smaller than that of the first through-hole 115.

### Second Exemplary Embodiment

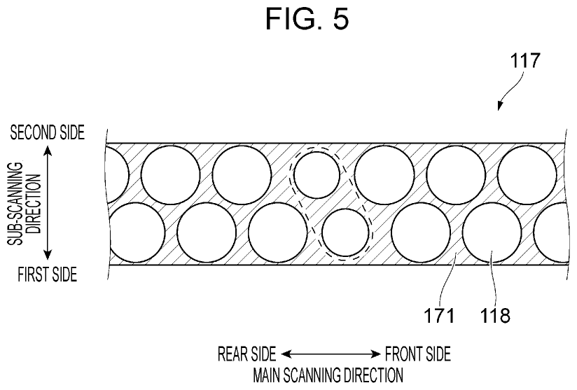

FIG. 5 is a plan view illustrating an example of an external configuration of a light shielding film 171 provided between a light shielding wall and the microlens array 117 in a CIS of an image reading device according to a second exemplary embodiment. In the following description of the second exemplary embodiment, the same components as those of the first exemplary embodiment are denoted by the same reference numerals.

The configuration of the image reading device as an optical device to which the second exemplary embodiment is applied is basically the same as that of the image reading device 1 according to the first exemplary embodiment described above, but is different in that the light shielding film 171 is provided between the light shielding wall and the microlens array 117 mounted on the CIS. Therefore, an external configuration of the microlens array 117 and a configuration of the light shielding film 171 will be described with reference to FIG. 5.

As described above, the microlens array 117 is arranged such that each of the plurality of microlenses 118 configurating the microlens array 117 itself and each of the plurality of first through-holes 115 (see, for example, FIG. 4A) configurating the light shielding wall 113 have a paired relationship. Therefore, as illustrated in FIG. 5, the plurality of microlenses 118 configurating the microlens array 117 is arranged in rows at equal intervals or substantially equal intervals in the main scanning direction. Specifically, the plurality of microlenses 118 is arranged in a row on each of a first side and a second side of the microlens array 117 in the sub-scanning direction.

The light shielding film 171 is a film that suppresses the amount of light condensed from the second through-hole 116 (for example, see FIG. 4A) and is provided between the light shielding wall 113 and the microlens array 117. The light shielding film 171 is configurated by, for example, paint that has a light shielding effect and is applied to an upper surface of the microlens array 117.

The light shielding film 171 is provided such that the microlens 118 opposed to the first through-hole 115 is not shielded from light and the microlens 118 corresponding to the second through-hole 116 is partially shielded from light. That is, the light shielding film 171 is provided such that the area of the portion shielding the microlens 118 corresponding to the second through-hole 116 from light is larger than the area of the portion shielding the other microlenses 118 from light. Specifically, as illustrated in FIG. 5, the portion of the light shielding film 171 surrounded by a broken line is the portion shielding the microlens 118 corresponding to the second through-hole 116 from light.

When the light shielding film 171 is provided between the light shielding wall 113 and the microlens array 117, the second through-hole 116 formed in the light shielding wall 113 does not need to be configurated to have a diameter smaller than that of the first through-hole 115 unlike the above-described first exemplary embodiment illustrated in FIGS. 4A to 4C. However, as in the first exemplary embodiment, the configuration may be such that the diameter of the second through-hole 116 is smaller than that of the first through-hole 115.

### Third Exemplary Embodiment

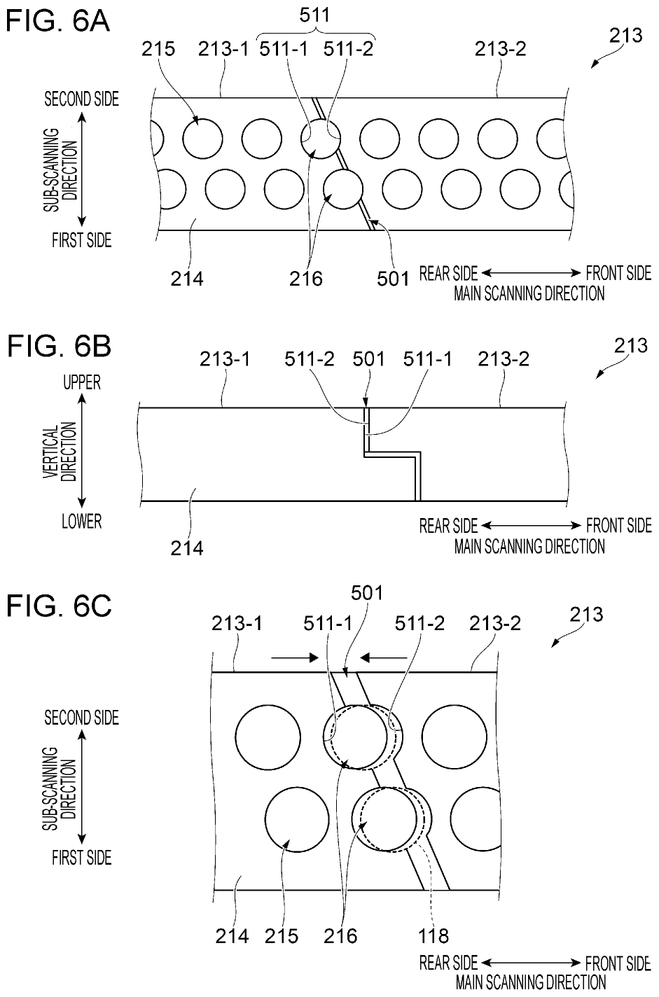

FIGS. 6A to 6C are diagrams illustrating an example of an external configuration of a light shielding wall 213 mounted on a CIS of an image reading device according to a third exemplary embodiment. In the following description of the third exemplary embodiment, the same components as those of the first exemplary embodiment are denoted by the same reference numerals.

The configuration of the image reading device as an optical device to which the third exemplary embodiment is applied is basically the same as that of the image reading device 1 according to the first exemplary embodiment described above, but is different in the configuration of a light shielding wall mounted on the CIS. Therefore, the configuration of the light shielding wall 213 according to the third exemplary embodiment will be described with reference to FIGS. 6A to 6C.

The light shielding wall 213 includes a light shielding portion 214 and a plurality of first through-holes 215 having a circular shape in cross-section. The plurality of first through-holes 215 is arranged in rows at equal intervals or substantially equal intervals in the main scanning direction. Specifically, as illustrated in FIG. 6A, the plurality of first through-holes 215 is arranged in a row on each of a first side and a second side of the light shielding wall 213 in the sub-scanning direction. The configuration of the first through-hole 215 is the same as that of the first through-hole 115 of the light shielding wall 113 (for example, see FIG. 4A) according to the above-described first or second exemplary embodiment, and the description thereof will be omitted.

Furthermore, the light shielding wall 213 includes a cutout portion 511 that divides the light shielding wall 213 itself in the longitudinal direction (i.e., the main scanning direction). FIGS. 6A to 6C illustrate a light shielding wall 213-1 and a light shielding wall 213-2 among the divided light shielding walls 213 and a gap 501 formed therebetween. The light shielding wall 213-1 includes a cutout portion 511-1 at an end portion on the front side in the main scanning direction. Further, the light shielding wall 213-2 includes a cutout portion 511-2 at an end portion on the rear side in the main scanning direction.

The cutout portions 511-1 and 511-2 configurate a part of the cutout portion 511 and form two second through-holes 216. As is the case with the first through-hole 215, the second through-hole 216 is a through-hole that allows passage of light.

In the light shielding wall 213, among the adjacent light shielding walls, a part of an end portion of one light shielding wall and a part of an end portion of the other light shielding wall overlap with each other in the longitudinal direction (i.e., the main scanning direction) of the second through-hole 216. In the example illustrated in FIGS. 6A to 6C, a part of the end portion of the light shielding wall 213-1 and a part of the end portion of the light shielding wall 213-2 overlap with each other in the longitudinal direction of the second through-hole 216. Specifically, as illustrated in FIG. 6B that illustrates the state of the light shielding wall 213 when viewed from the first side to the second side in the sub-scanning direction, a part of the end portion of the light shielding wall 213-1 on the front side in the main scanning direction is located on the lower side in the vertical direction, and a part of the end portion of the light shielding wall 213-2 on the rear side in the main scanning direction is overlapped to be located on the upper side in the vertical direction.

As illustrated in FIG. 6C, the two second through-holes 216 formed by the cutout portion 511-1 and the cutout portion 511-2 each have the same or substantially the same diameter as that of the first through-hole 215 in the portion penetrating the light shielding wall 213-1 and have a larger diameter in the main scanning direction than that of the first through-hole 215 in the portion penetrating the light shielding wall 213-2.

That is, unlike the second through-hole 116 according to the first or second exemplary embodiment described above, the second through-hole 216 according to the third exemplary embodiment is not formed to have a diameter smaller than that of the first through-hole 215. This is because a part of the end portion of the light shielding wall 213-1 and a part of the end portion of the light shielding wall 213-2 overlap with each other in the longitudinal direction of the second through-hole 216, and thus the amount of light leaking from the gap 501 is suppressed without making the diameter of the second through-hole 216 smaller than that of the first through-hole 215.

The broken line portions in FIG. 6C indicate the positions of the microlenses 118. As illustrated in FIG. 6C, the position of the second through-hole 216 is located at a position shifted to the rear side in the main scanning direction from the position of the microlens 118. The positional relationship between the second through-hole 216 and the microlens 118 is set in consideration of an environmental change such as temperature change and moisture absorption. For example, when a temperature increase occurs and each of the light shielding wall 213-1 and the light shielding wall 213-2 thermally expands in the direction of the arrow of FIG. 6C, the second through-hole 216 located at a position shifted to the rear side in the main scanning direction from the position of the microlens 118 moves to the front side in the main scanning direction and cancels at least part of the influence by the thermal expansion.

The cross-sectional shape of the second through-hole 216 is not particularly limited, as is the case with the second through-hole 116 of the light shielding wall 113 according to the first or second exemplary embodiment described above. For example, as illustrated in FIG. 6A, the cross-sectional shape of the second through-hole 216 may be a circular shape, an elliptical shape, a rectangular shape, a gourd shape, or the like. Further, the cross-sectional shape of the second through-hole 216 may be determined based on the shape and the size of the microlens of the microlens array.

### Other Exemplary Embodiments

Although the present exemplary embodiment has been described above, an exemplary embodiment of the invention is not limited to the above-described present exemplary embodiment. Further, the effects of the exemplary embodiment of the invention are not limited to those described in the above-described present exemplary embodiment. For example, the configurations of the image reading device 1 illustrated in FIG. 1, the CIS 11 illustrated in FIGS. 2A and 2B, the light shielding wall 113 illustrated in FIGS. 3 and 4A to 4C, the light shielding film 171 illustrated in FIG. 5, and the light shielding wall 213 illustrated in FIGS. 6A to 6C are merely examples for achieving the object of the exemplary embodiment of the invention and are not particularly limited. It is sufficient as long as the above-described functions are provided in the image reading device 1 and the CIS 11, and the configuration to be used to perform these functions is not limited to the above-described example.

For example, unlike the second through-hole according to the first exemplary embodiment, the second through-hole according to the third exemplary embodiment is not configurated to have a smaller diameter than that of the first through-hole, but is not limited thereto, and may be configurated to have a smaller diameter than that of the first through-hole.

### APPENDIX

(((1)))

An optical device comprising:
a light shielding wall including a light shielding portion that shields light from a light source, a first through-hole and a second through-hole that allow passage of light from the light source, the second through-hole having a smaller diameter than the first through-hole, and a cutout portion that forms the second through-hole;
a microlens array configurated by a plurality of lenses that condenses light having passed through the first through-hole and the second through-hole; and
an image sensor that reads the light condensed by the microlens array.
   (((2)))

The optical device according to (((1))), wherein the cutout portion is formed at an end portion of the light shielding wall by dividing the light shielding wall, and a shape of the cutout portion is determined in consideration of a change in a positional relationship between the first through-hole and the second through-hole and a lens of the microlens array due to an environmental change.

(((3)))

The optical device according to (((2))), wherein the change in the positional relationship due to the environmental change is thermal expansion of the light shielding wall.

(((4)))

The optical device according to (((2))) or (((3))), wherein the shape of the cutout portion is determined based on a contraction rate of the light shielding wall.

(((5)))

The optical device according to any one of (((1))) to (((4))), wherein a cross-sectional shape of the second through-hole formed by the cutout portion is a circular shape, an elliptical shape, a rectangular shape, or a gourd shape.

(((6)))

The optical device according to (((5))), wherein the cross-sectional shape of the second through-hole is determined based on a shape and a size of a lens of the microlens array.

(((7)))

An optical device comprising:
a light shielding wall including a light shielding portion that shields light from a light source, a first through-hole and a second through-hole that allow passage of light from the light source, and a cutout portion that forms the second through-hole;
a microlens array configurated by a plurality of lenses that condenses light having passed through the first through-hole and the second through-hole; and
an image sensor that reads the light condensed by the microlens array, wherein
among the adjacent light shielding walls, a part of an end portion of one light shielding wall and a part of an end portion of the other light shielding wall overlap with each other in a longitudinal direction of the second through-hole.
   (((8)))

The optical device according to (((7))), wherein the cutout portion at the end portion of the one light shielding wall and the cutout portion at the end portion of the other light shielding wall are located at positions in consideration of a change in a positional relationship between the first through-hole and the second through-hole and a lens of the microlens array due to an environmental change.

(((9)))

An optical device comprising:
a light shielding wall including a light shielding portion that shields light from a light source, a through-hole that allows passage of light from the light source, and a cutout portion that forms the through-hole;
a microlens array that is configurated by a plurality of lenses that condenses light having passed through the through-hole and for which a light shielding film is provided to suppress an amount of light condensed from the through-hole formed in the cutout portion; and
an image sensor that reads light condensed by the microlens array.
   (((10)))

The optical device according to (((9))), wherein an area of the light shielding film provided for a lens corresponding to the cutout portion is larger than an area of the light shielding film provided for the other lenses.

What is claimed is:

1. An optical device comprising:
a light shielding wall including a light shielding portion that shields light from a light source, a first through-hole and a second through-hole that allow passage of light from the light source, the second through-hole having a smaller diameter than the first through-hole, and a cutout portion that forms the second through-hole;
a microlens array configurated by a plurality of lenses that condenses light having passed through the first through-hole and the second through-hole; and
an image sensor that reads the light condensed by the microlens array.

2. The optical device according to claim 1, wherein the cutout portion is formed at an end portion of the light shielding wall by dividing the light shielding wall, and a shape of the cutout portion is determined in consideration of a change in a positional relationship between the first through-hole and the second through-hole and a lens of the microlens array due to an environmental change.

3. The optical device according to claim 2, wherein the change in the positional relationship due to the environmental change is thermal expansion of the light shielding wall.

4. The optical device according to claim 3, wherein the shape of the cutout portion is determined based on a contraction rate of the light shielding wall.

5. The optical device according to claim 1, wherein a cross-sectional shape of the second through-hole formed by the cutout portion is a circular shape, an elliptical shape, a rectangular shape, or a gourd shape.

6. The optical device according to claim 5, wherein the cross-sectional shape of the second through-hole is determined based on a shape and a size of a lens of the microlens array.

7. An optical device comprising:
a light shielding wall including a light shielding portion that shields light from a light source, a first through-hole and a second through-hole that allow passage of light from the light source, and a cutout portion that forms the second through-hole;
a microlens array configurated by a plurality of lenses that condenses light having passed through the first through-hole and the second through-hole; and
an image sensor that reads the light condensed by the microlens array, wherein
among the adjacent light shielding walls, a part of an end portion of one light shielding wall and a part of an end portion of the other light shielding wall overlap with each other in a longitudinal direction of the second through-hole.

8. The optical device according to claim 7, wherein the cutout portion at the end portion of the one light shielding wall and the cutout portion at the end portion of the other light shielding wall are located at positions in consideration of a change in a positional relationship between the first through-hole and the second through-hole and a lens of the microlens array due to an environmental change.

9. An optical device comprising:
a light shielding wall including a light shielding portion that shields light from a light source, a through-hole that allows passage of light from the light source, and a cutout portion that forms the through-hole;
a microlens array that is configurated by a plurality of lenses that condenses light having passed through the through-hole and for which a light shielding film is provided to suppress an amount of light condensed from the through-hole formed in the cutout portion; and
an image sensor that reads light condensed by the microlens array.

10. The optical device according to claim 9, wherein an area of the light shielding film provided for a lens corresponding to the cutout portion is larger than an area of the light shielding film provided for the other lenses.
